(19) United States
(12) Patent Application Publication
(10) Pub. No.: US 2008/0078838 A1
(43) Pub. Date: Apr. 3, 2008

(54) Wearable data acquisition device

(76) Inventors: Quintin Morris, Brooklyn, NY (US); Robert Liao, South Setauket, NY (US)

Correspondence Address: FAY KAPLUN & MARCIN, LLP, 15O BROADWAY, SUITE 702, NEW YORK, NY, 10038, US

(21) Appl. No.: 11/541,270

(22) Filed: Sep. 29, 2006

(51) Int. Cl. G06K 7/10; G06K 7/00

(52) U.S. Cl. 235/462.44; 235/439

(57) ABSTRACT

A wearable data acquisition device includes (i) a housing unit having a data acquisition arrangement and a base portion. The base portion includes a connector and a triggering area. The device also includes (ii) a trigger unit worn by a user. The trigger unit has a triggering mechanism for engaging the triggering area and a receiving arrangement adapted to receive the connector in an attached configuration. When in the attached configuration, the housing is rotatable about an axis substantially perpendicular to a bottom surface of the base portion.

### FIELD OF THE INVENTION

The present invention generally relates to wearable devices and, in particular, to wearable data acquisition devices.

### BACKGROUND INFORMATION

Conventional wearable data acquisition devices, such as ring scanners, often include an attachment arrangement integrally coupled to a housing thereof. The attachment arrangement is non-removable. In addition, a triggering mechanism is also integral with the housing and does not allow for ambidextrous operation of the data acquisition device. If the attachment arrangement or the trigger mechanism break, the entire device must be replaced.

### SUMMARY OF THE INVENTION

The present invention relates to a wearable data acquisition device which includes (i) a housing unit having a data acquisition arrangement and a base portion. The base portion includes a connector and a triggering area. The device also includes (ii) a trigger unit worn by a user. The trigger unit has a triggering mechanism for engaging the triggering area and a receiving arrangement adapted to receive the connector in an attached configuration. When in the attached configuration, the housing is rotatable about an axis substantially perpendicular to a bottom surface of the base portion.

### BRIEF DESCRIPTION OF THE DRAWINGS

FIG. 1 is an exemplary embodiment of a data acquisition device according to the present invention.

FIG. 2 is an exemplary embodiment of a housing assembly of a data acquisition device according to the present invention.

FIG. 3 is an exemplary embodiment of a trigger assembly according to the present invention.

FIG. 4 is another exemplary embodiment of a trigger assembly according to the present invention.

### DETAILED DESCRIPTION

The present invention may be further understood with reference to the following description and the appended drawings, wherein like elements are provided with the same reference numerals. The present invention relates to wearable data acquisition devices. An exemplary embodiment of the present invention is described with reference to a ring scanner, however those skilled in the art will understand that the present invention may be implemented with any type of wearable data acquisition device, such as a wrist-mounted scanner, a glove scanner, etc. It will also be understood that the present invention is not limited to barcode scanners, but may also include RFID readers, laser-/image-based scanners, card readers and other types of data acquisition devices.

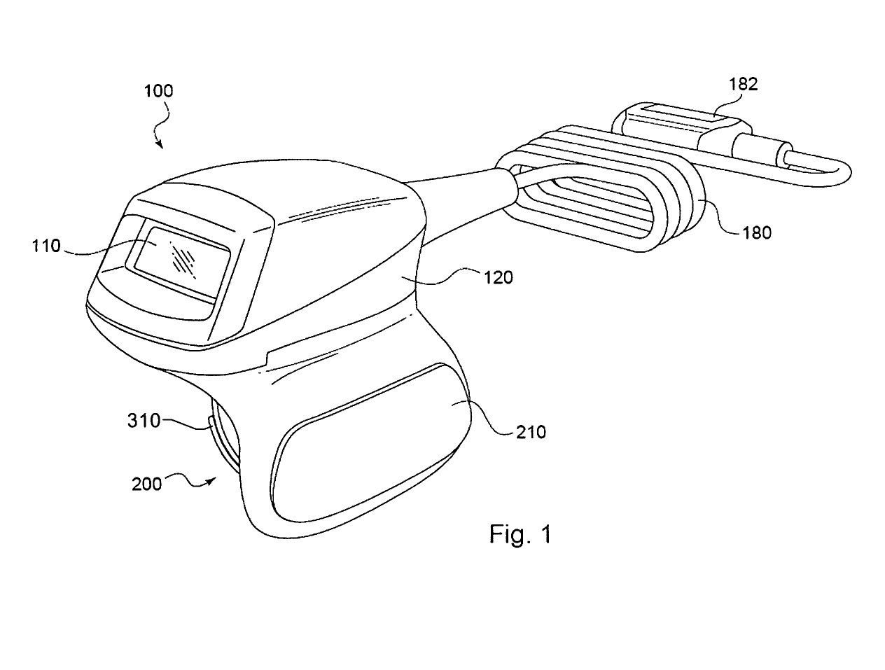

FIG. 1 shows an exemplary embodiment of a data acquisition device (e.g., a ring scanner) 100 according to the present invention. The scanner 100 includes a housing assembly (e.g., a housing unit 120), which comprises a scanning arrangement (e.g., a barcode scanner) 110. The housing 120 may be coupled to a communication arrangement, such as data cable 180. The data cable 180 may transfer data to and/or from the scanner 100. For example, the data cable 180 may include a hardware connector 182 (e.g., a parallel port connector, a serial port connector, a USB connector, etc.) that couples the scanner 100 to a data storage device such as a computer, a PDA, a mobile terminal, etc. Thus, the data cable 180 may allow the scanner 100 to transmit scanned images to the data storage device and receive instructions therefrom.

The scanner 100 may also include a trigger assembly (e.g., a trigger unit 200) detachably coupled to the housing 120. The trigger unit 200 may include an adjustable strap 310 for securing the scanner 100 to a body of a user. For example, the strap 310 may be a Velcro® strap sized to fit around a finger of the user. In other embodiments, other types of attachment mechanisms, such as elastic bands, adhesives, snap enclosures, etc. may be utilized. The strap 310 may be detachably coupled to the trigger unit 200. For example, the strap 310 may wrap around one or more hooks, loops, etc. disposed on the trigger unit 200. The strap 310 may be removed by unhooking and thus, may be replaced when wearing and/or breakage occurs.

The trigger unit 200 includes a trigger portion 210, which may comprise any type of mechanical and/or electrical switch. For example, the trigger 210 may be a push button, a rocker switch, a slide switch, etc. In an exemplary embodiment, the trigger 210 may be a mechanical push button encased within a flexible membrane (e.g., a rubber cover). The trigger 210 is communicatively coupled to the housing 120. Thus, engaging the trigger 210 by depressing the flexible membrane activates the scanner 100, enabling a scanning of a barcode or another function. The coupling of the trigger 210 to the housing 120 will be described in detail below.

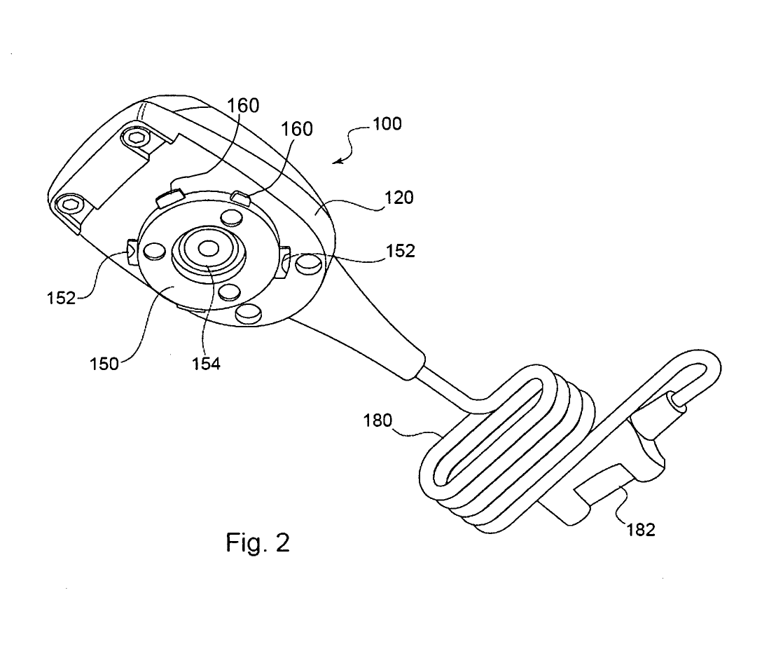

FIG. 2 shows an exemplary embodiment of the scanner 100 in a detached configuration. The exemplary embodiment shown is a bottom view of the housing 120. A lower (e.g., base) portion of the housing 120 includes a mechanical connector (e.g., a turret 150) for attaching the trigger unit 200. The turret 150 may, for example, be a male connector shaped as a ring adapted for insertion into the trigger unit 200. The turret 150 may be formed of the same or substantially similar materials as the housing 120. For example, the turret 150 may be a hard plastic, a polymer, or any other substantially rigid material. An outer circumference of the turret 150 may include one or more tabs 160. As will be described below, the trigger unit 200 may be shaped to receive the tabs 160 when the housing 120 and the trigger unit 200 are aligned in a receiving configuration. One or more of the tabs 160 may include a recess or cut-out 152, which, in conjunction with a locking device, prevents movement of the housing 100 with respect to the trigger unit 200.

A triggering area 154 of the housing 120 is communicatively coupled to the trigger unit 200. When the trigger 210 is engaged, a mechanical and/or electrical connection between the trigger unit 200 and the triggering area 154 is established. For example, if the connection is the mechanical connection, the triggering area 154 may receive a shaft, a gear, etc. If the connection is the electrical connection, the triggering area 154 may receive an electrical contact, a wire, etc.

The turret 150 may cover a portion of the triggering area 154. In an exemplary embodiment, the turret 150 may, for example, circumscribe the triggering area 154, shielding the triggering area 154 from exposure. However, in other embodiments, the turret 150 may not cover the triggering area 154.

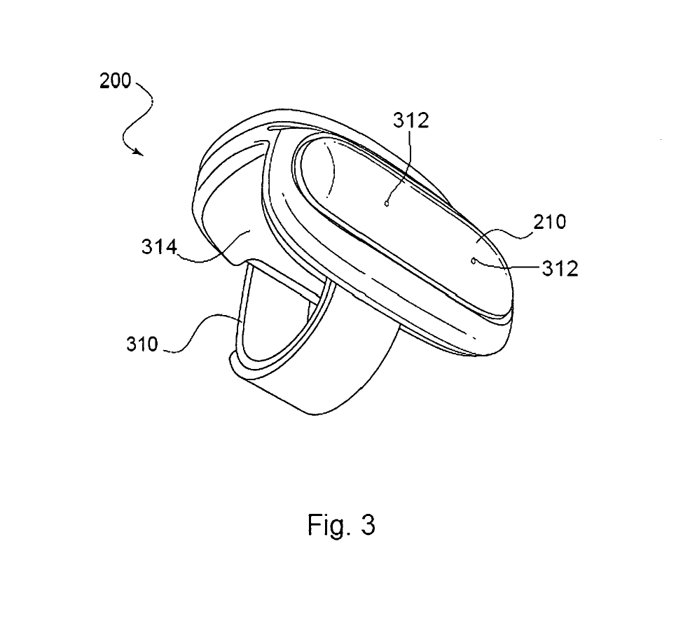

FIG. 3 shows an exemplary embodiment of the trigger unit 200 according to the present invention. The trigger unit 200 may be shaped to conform to the finger of the user. For example, an interior surface 314 of the trigger unit 200 may be partially or substantially cylindrical. In addition, the trigger unit 200 may be sized to allow for unrestricted movement (e.g., bending) of the finger. For example, a length of the trigger unit 200 may be substantially the same as a proximal phalanx of the finger.

The trigger 210 may include one or more holes 312 in the flexible membrane that allow air to be expelled when the trigger 210 is engaged. This arrangement allows the flexible membrane to cover the push button disposed within the trigger 210 without actually contacting the button. The button only activates when the flexible membrane collapses and makes contact, after a sufficient amount of air has been expelled. In order to collapse the flexible membrane, a sufficient amount and/or duration of pressure must be applied to the trigger 210. After the trigger 210 is disengaged, air returns through the holes 312 and the flexible membrane returns to an uncollapsed state. Thus, the trigger 210 may be protected against accidental triggering.

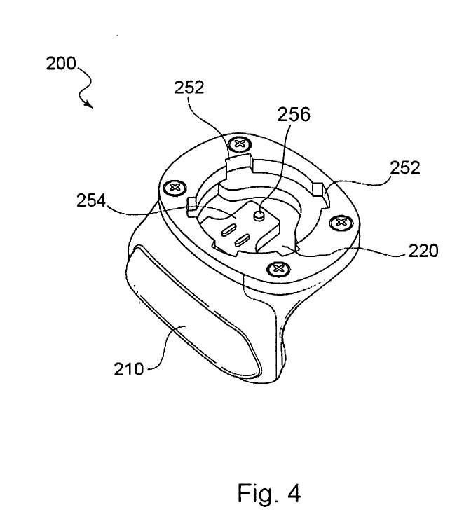

FIG. 4 shows an exemplary embodiment of a top view of the trigger unit 200. The trigger unit 200 may include a hollow portion 220 that receives the turret 150. The hollow portion 220 may include one or more slots 252 shaped to receive the tabs 160. Thus, the housing 100 may only be inserted into the hollow portion 210 if the tabs 160 are aligned with the slots 252. If the tabs 160 are not aligned, the housing 100 is prevented from insertion.

After the housing 100 is inserted, the trigger unit 200 may be secured using a locking device, such as a screw, a bushing, a dowel, etc. The locking device may be inserted via a port (e.g., a threaded hole) disposed on the interior surface 314. For example, if the locking device is the screw, it may be inserted through the port such that a shaft end of the screw extends beyond a lower surface of the tabs 160. In other embodiments, the port may be disposed elsewhere (e.g., a side of) on trigger unit 200. When the housing 100 is rotated in either a clockwise or a counterclockwise fashion about an axis substantially perpendicular to a bottom surface of the base portion, the shaft end is eventually received within the recess 152 and the housing 100 is prevented from further rotation. Thus, rotational motion may be constrained to prevent the tabs 160 from becoming aligned with the slots 252 and the housing 100 cannot be detached from the trigger unit 100. If detachment is desired, the locking device may be removed (e.g., by unscrewing). The housing 100 may then be rotated until the tabs 160 and the slots 252 are aligned, and the trigger unit 200 separated.

In an exemplary embodiment, the rotation may be restricted to 180 degrees. This allows the housing 100 to be rotated between a forward facing position in which the trigger 210 is oriented along a left side of the housing 100 and a rearward facing position in which the trigger 210 is oriented along a right side of the housing 100. Thus, the housing 100 may be positioned to allow for both left- and right-handed operation. For example, if left-handed operation is desired, the user may slip the trigger unit 200 over the finger such that the trigger 210 may be engaged by a left thumb. If necessary, the housing 100 may then be rotated to the rearward facing position (i.e., when the scanning arrangement 110 is in a distal-most position).

The hollow portion 220 may include a trigger mechanism (e.g., a trigger plate 254). The trigger plate 254 is activated by engaging the trigger 210 and may include a nub 256. Activation may involve pivoting the trigger plate 254 about a lateral axis of the trigger unit 200. This pivoting action causes the nub 256 to be elevated above the hollow portion 220 and contact the triggering area 154. When the trigger 210 is disengaged, the trigger plate 254 returns to a resting position within the hollow portion 220.

The exemplary embodiments of the scanner 100 described above present several advantages over a conventional data acquisition device. For example, the strap 310 and the entire trigger unit 200 are replaceable. During use, the trigger unit 200 may break. In such an instance, the trigger unit 200 may be replaced rather than discarding the entire scanner 100.

In addition, the scanner 100 may be easily converted for ambidextrous operation. The locking device prevents separation of the housing 100 and the trigger unit 200 while enabling rotation between various operating positions. For example, the scanning arrangement 110 may be oriented in a lateral direction. Other orientations may also be possible depending on how the user wishes to scan a barcode (e.g., using a forward rotational motion of the wrist/arm, using a lateral rotational motion of the wrist/arm, etc.).

The trigger unit 200 may be compatible with a plurality of scanners. For example, the trigger unit 200 may, in addition to the scanner 100, be compatible with an infrared scanner, an RFID reader, etc. In some embodiments, the locking device may allow the housing 100 to be quickly detached and replaced with another scanner. For example, the locking device may be coupled to a release mechanism (e.g., a spring, a pull tab, etc.) disposed along a side of the trigger unit 200. In other embodiments, the locking device itself may be inserted/removed via the side (e.g., a side port) of the trigger unit 200. Thus, the housing 100 may be detached without removing trigger unit 200 from the user's finger.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A wearable data acquisition device, comprising:
a housing unit including a data acquisition arrangement and a base portion, the base portion including a connector and a triggering area; and
a trigger unit worn by a user, the trigger unit including a triggering mechanism for engaging the triggering area and a receiving arrangement adapted to receive the connector in an attached configuration,
wherein when in the attached configuration, the housing is rotatable about an axis substantially perpendicular to a bottom surface of the base portion.

2. The data acquisition device of claim 1, wherein the connector comprises a tabbed ring including a plurality of tabs radially extending from an outer circumference thereof.

3. The data acquisition device of claim 2, wherein the receiving arrangement includes a plurality of slots shaped to receive the plurality of tabs.

4. The data acquisition device of claim 3, wherein the housing unit is detached from the trigger unit only when the slots are aligned with the tabs.

5. The data acquisition device of claim 1, wherein the trigger unit includes a locking device maintaining the housing in the attached configuration.

6. The data acquisition device of claim 5, wherein the locking device, by engaging at least one tab portion of the connector, prevents the housing unit from completing a 360 degree rotation.

7. The data acquisition device of claim 6, wherein the locking device engages a grooved portion of the at least one tab portion.

8. The data acquisition device of claim 5, wherein the locking device is one of a screw, a dowel, and a bushing.

9. The data acquisition device of claim 5, wherein the locking device is inserted through one of a side and a bottom surface of the trigger unit.

10. The data acquisition device of claim 5, wherein the trigger unit includes a release mechanism which removes the locking device.

11. The data acquisition device of claim 10, wherein the release mechanism is activated when the data acquisition device is worn.

12. The data acquisition device of claim 1, wherein the trigger unit includes a mechanical trigger that exits a receiving area of the trigger unit to engage the triggering area when the triggering mechanism is activated.

13. The data acquisition device of claim 1, wherein the rotation is between a right-handed configuration and a left-handed configuration.

14. The data acquisition device of claim 1, wherein the trigger unit is operationally attachable to a second housing unit of a second data acquisition device.

15. The data acquisition device of claim 1, wherein the triggering mechanism is an electrical mechanism.

16. The data acquisition device of claim 1, wherein the triggering mechanism is encased within a flexible membrane.

17. The data acquisition device of claim 1, further comprising:
an adjustable strap detachably coupled to one of the trigger unit and the housing unit.

18. The adjustable strap of claim 17, wherein the strap is sized to fit around a body part of a user.

19. A trigger unit for a wearable device, comprising:
a trigger receiving input data from a user of the wearable device;
a triggering mechanism communicating the input data to the wearable device; and
a rotatable connector coupling the trigger unit to the wearable device,
wherein when in the coupled configuration, the trigger unit housing is rotatable about an axis of the wearable device,
wherein when in a first position, the combination of the wearable device and the trigger unit is provided for a right-handed operation, and
wherein when in a second position, the combination of the wearable device and the trigger unit is provided for a left-handed operation.

20. A wearable data acquisition device, comprising:
a housing unit including a data acquisition means and a base portion, the base portion including a connecting means and a triggering area; and
a trigger unit worn by a user, the trigger unit including a triggering means for engaging the triggering area and a receiving means for receiving the connecting means in an attached configuration,
wherein when in the attached configuration, the housing is rotatable about an axis substantially perpendicular to a bottom surface of the base portion.
